(19) United States
(12) Patent Application Publication
(10) Pub. No.: US 2008/0104691 A1
(43) Pub. Date: May 1, 2008

(54) Communication system

(75) Inventors: Nobuyuki Takeda, Hachioji-shi (JP); Shigeru Fukazawa, Hachioji-shi (JP); Yasumasa Sasaki, Tachikawa-shi (JP); Koji Shima, Sagamihara-shi (JP); Fumikazu Matsukawa, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,396

(22) Filed: Oct. 24, 2007

(30) Foreign Application Priority Data
Oct. 31, 2006 (JP) 2006-296633

(51) Int. Cl. G06F 21/00

(52) U.S. Cl. 726/14

(57) ABSTRACT

According to one embodiment, a communication system includes a plurality of communication terminals and a server apparatus, the server apparatus includes a first memory stores a group table which correlates the connection information with the groups, a terminal ID of a first communication terminal, and a terminal ID of a second communication terminal, a notifying unit refers to the group table, notify a first communication terminal in each group of a server ID, based on the result of reference, and a first transmitter compares the terminal ID included in the acquisition request with terminal IDs in the group table, transmits adequate connection information to the first communication terminal, based on the result of comparison, and the first communication terminal includes a second memory stores the server ID, a second transmitter transmits the connection information acquisition request to the server apparatus, a controller sets the connection information in the processor.

### CROSS-REFERENCE TO RELATED APPLICATIONS

This application is based upon and claims the benefit of priority from Japanese Patent Application No. 2006-296633, filed Oct. 31, 2006, the entire contents of which are incorporated herein by reference.

### BACKGROUND

1. Field

One embodiment of the present invention relates to a communication system for communication among communication terminals through a communication server, such as SIP (Session Initiation Protocol).

2. Description of the Related Art

Recently, a network telephone system (IP telephone system), which performs real-time two-way transmission and reception of images and voices as packet data through a packet network, has been become popular.

In such kind of system, an IP address of a terminal connected to a packet network is previously registered in a communication server on a packet network, and the communication server authenticates the terminal based on its registered IP address.

In the above system, it is necessary to set connection information in both communication server and terminal for connecting a terminal to a communication server. The connection information needs to be updated in each communication server and terminal, whenever a numbering plan is changed, or a terminal is added. However, setting and updating of information for connecting terminals are manually performed by a system administrator upon visiting to each terminal. Thus, if a large number of terminals are connected, or a terminal exists in a distant place, setting and updating require much time and labor.

In an electronic mail system, it is proposed that a mail server stores setting formation of each mail client, and when receiving an IP address of a mail client from a mail client, the mail server sends adequate setting information to that mail client, and the mail client sets the setting information in the client's own apparatus, whereby the information is automatically set without the system administrator's manual operation (for example, Jpn. Pat. Appln. KOKAI Publication No. 2004-172795).

However, in the above-proposed method, if setting information requests from mail clients are concentrated in the same time zone, circuits are occupied by one main server, and effective use of circuits becomes difficult.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic block diagram of a communication system according to a first embodiment of the invention;

FIG. 2 is an example of a group table stored in a storage device shown in FIG. 1;

FIG. 3 is a block diagram showing the function/configuration of an application server shown in FIG. 1;

FIG. 4 is a block diagram showing the function/configuration of representative client terminals shown in FIG. 1;

FIG. 5 shows a sequence of information transmission/reception among an application server, a storage device and a representative client terminal, when obtaining and setting the connection information in the first embodiment;

FIG. 6 is a block diagram showing the function/configuration of the other client terminals than the representatives, as a second embodiment of the invention; and

FIG. 7 shows a sequence of information transmission/reception among an application server, a storage device, representative client terminals and other clients terminals, when obtaining and setting the connection information in the second embodiment.

### DETAILED DESCRIPTION

Various embodiments according to the invention will be described hereinafter with reference to the accompanying drawings. In general, according to one embodiment of the invention, a communication system comprising: a plurality of communication terminals are connected a communication network, are assigned terminal IDs, and execute communication by setting in a processor a connection information necessary for execution of communication among the communication terminals; a server apparatus is connected the communication terminals through the communication network, is assigned server ID, and informs the communication terminals of the connection information; wherein the server apparatus comprises a first memory which stores a group table which correlates with the groups formed by dividing the communication terminals, a terminal ID of a first communication terminal as the representative of the groups, a terminal ID of a second communication terminal different from the first communication terminal, and the connection information; a notifying unit to refer to the group table, and notify a first communication terminal in each group of a server ID, based on a result of reference; and a first transmitter which compares the terminal ID of the first communication terminal included in the acquisition request with terminal IDs in the group table, when the connection information acquisition request is sent from the first communication terminal in response to the notification of server ID, and transmits adequate connection information in the group table to the first communication terminal, based on a result of comparison, and the first communication terminal comprises a second memory which stores the server ID when the server ID is notified by the server apparatus; a second transmitter which transmits the connection information acquisition request to the server apparatus, based on the server ID stored in the second memory; and a controller which sets the connection information in the processor, when the connection information is sent from the server apparatus in response to the acquisition request.

### EMBODIMENT 1

FIG. 1 is a schematic block diagram of a communication system according to a first embodiment of the invention.

The system has a communication line 1 for transmitting video signals and computer data. The communication line 1 is connected with client terminals VC11-VC1n (n: natural number) as communication terminals and routers RT1-RTm (m: natural number) through a hub HB1.

A general-purpose personal computer is used in the client terminals VC11-VC1n. The router RT1 is connected with client terminals VC21-VC2n through a hub HB2. The router RTm is connected with client terminals VCn1-VCnn through a hub HBn.

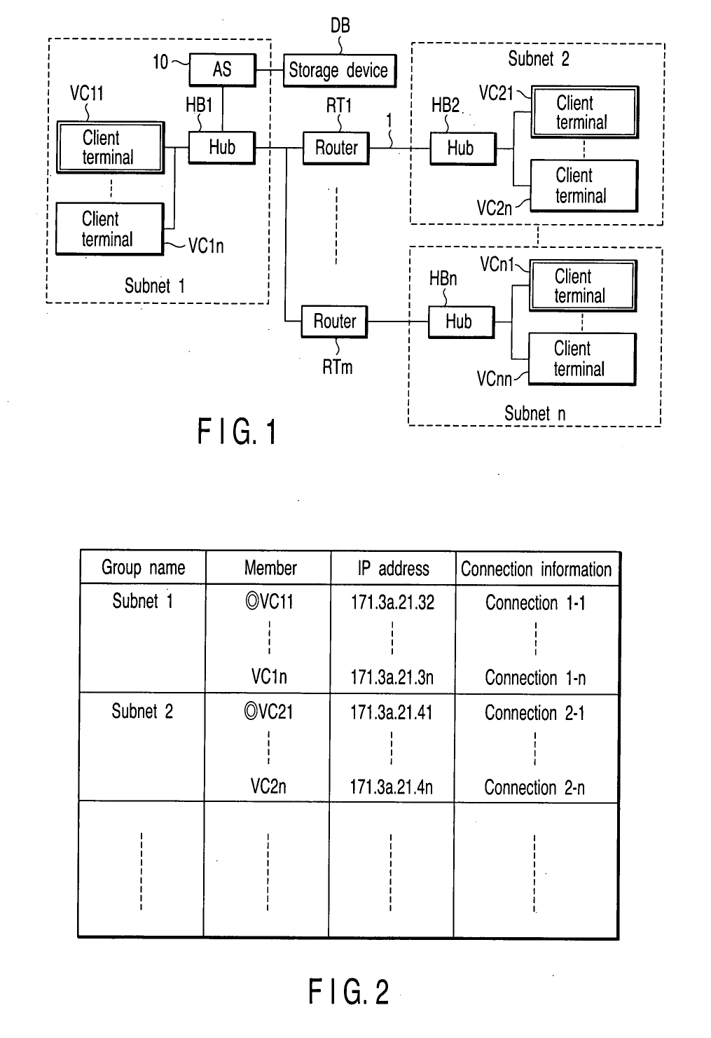

An application server (AS) 10 is connected to the communication line 1. A storage device DB is connected to the application server 10. As shown in FIG. 2, the storage device DB stores a group table indicating a correlation with subnets 1-n (group names) formed by dividing the client terminals VC11-VCnn, clients terminals VC11-VCnn belonging to the subnets 1-n and their IP addresses, and the connection information necessary for communication.

The application server 10 has an exchange control function for the client terminals VC11-VCnn.

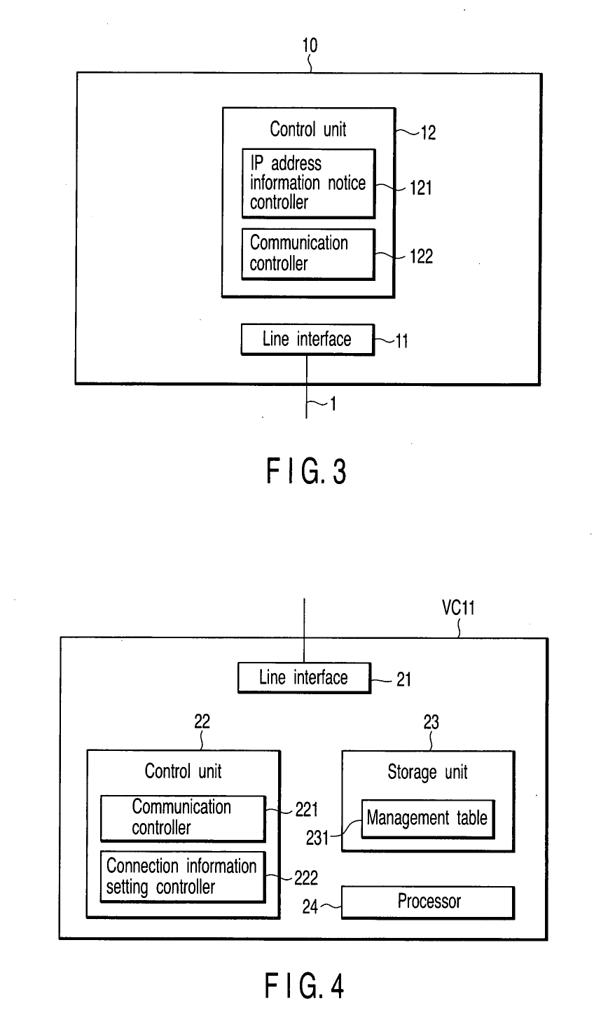

FIG. 3 is a block diagram showing the function/configuration of the application server 10.

The application server 10 has a line interface 11 and a control unit 12. The line interface 11 is used for interfacing with the communication line 1.

The control unit 12 has an IP address notice controller 121 (hereinafter, called a notice controller 121) and a communication controller 122 as additional functions according to the invention, in addition to the control function concerning the communication of client terminals VC11-VCnn.

The notice controller 121 refers to the group table in the storage device DB, and informs the client terminals VC11, VC21 . . . , VCn1 as the representatives of subnets 1-n of the IP address of the application server 10, based on the result of reference.

The communication controller 122 performs communication among client terminals VC11-VCnn through the communication circuit 1. The communication controller receives a connection information acquisition request sent from the client terminals VC11-VCnn, and sends the connection information stored in the storage device DB according to the acquisition request.

FIG. 4 is a block diagram showing the function/configuration of representative client terminals VC11, VC21, . . . VCn1. Explanation will be given on the client terminal VC11 as the representative.

The client terminal VC11 has a line interface 21, a control unit 22, a storage unit 23, and a processor 24. The line interface 21 is used for interfacing with the communication line 1.

The storage unit 23 is provided with a management table 231. The management table 231 stores IP addresses notified from the application server 10.

The control unit 22 has a control function to realize operation as the client terminal VC11, and has a communication controller 221 and a connection information setting controller 22 (hereinafter, called a setting controller 222).

The communication controller 221 performs communication with the application server 10 through the communication line 1. The communication controller 221 sends a connection information acquisition request to the application server 10 when receiving an IP address from the application server 10, and receives the connection information sent from the application server 10 in response to the acquisition request.

The setting controller 222 sets the connection information sent from the application server 10 in the processor 23.

The processor 24 makes connection with the application server 10 based on the set connection information. In this time, when receiving the connection acceptance from the application server 10, the setting controller 222 displays that message in a monitor (not shown) in OSD (On Screen Display) mode. Instead of OSD, lighting or flashing of LED (Light Emitting Diode) may be used.

Next, explanation will be given on the operation of the communication system configured as described above.

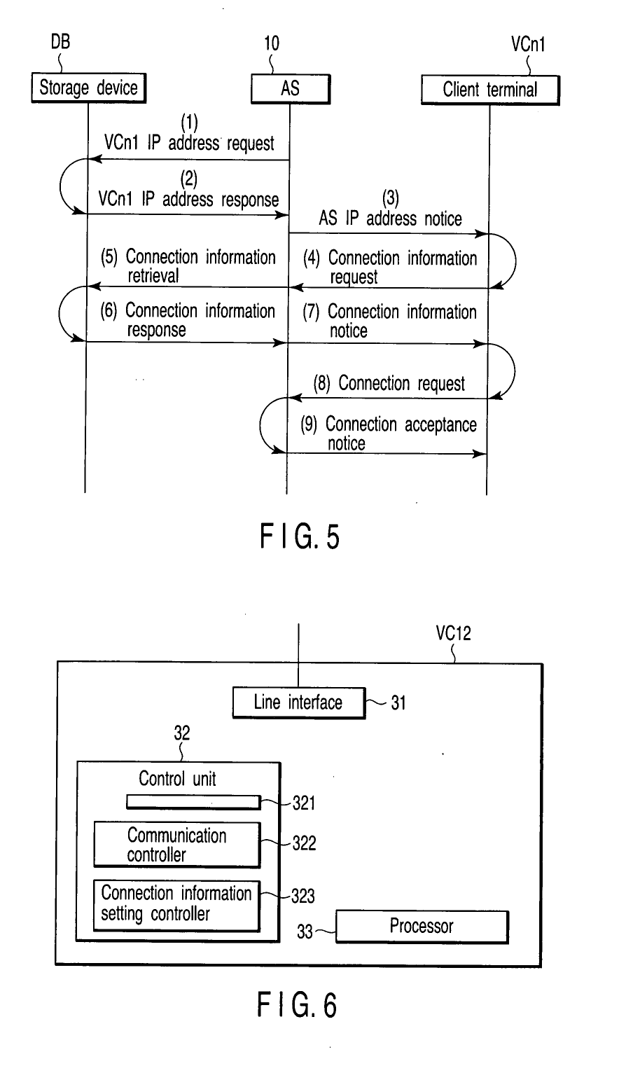

FIG. 5 shows a sequence of information transmission/reception among the application server 10, storage device DB and representative client terminal VCn1, when obtaining and setting the connection information.

The application server 10 requests the storage device DB to send the IP address of the client terminal VCn1 (FIG. 5 (1)). The storage device DB returns the stored IP address of the client terminal VCn1 to the application server 10 (FIG. 5 (2)).

The application server 10 informs the client terminal VCn1 of the IP address of the application server 10, based on the returned IP address of the client terminal VCn1 (FIG. 5 (3)).

The client terminal VCn1 stores the informed IP address of the application server 10 in the management table 231 of the storage unit 23. Based on the stored IP address of the application server 10, the client terminal VCn1 sends a connection information acquisition request to the application server 10 (FIG. 5 (4)).

The application server 10 retrieves appropriate connection information for connecting the client terminal VCn1 from the storage device DB, based on the IP address accompanying with the acquisition request received from the client terminal VCn1 (FIG. 5 (5)).

The storage device DB returns the connection information selected as a result of retrieval to the application server 10 (FIG. 5 (6)).

The application server 10 informs the client terminal VCn1 of the connection information returned from the storage device DB (FIG. 5 (7)).

The client terminal VCn1 sets the connection information returned from the application server 10 in the processor 24, and requests the application server 10 to make connection, based on that connection information (FIG. 5 (8)).

The application server 10 makes connection of the client terminal VCn1, and informs the client terminal VCn1 of the acceptance of connection of (FIG. 5 (9)). The client terminal VCn1 makes display to indicate under-connection upon receipt of the acceptance of connection.

The above steps are executed parallel for the subnets 1-n.

As explained above, in the first embodiment, the client terminals VC11-VCnn are divided into groups, the IP addresses of the groups and client terminals VC11-VCnn are correlated to the connection information in a group table, the group table is stored in the storage device DB, the group table stored in the storage device DB is referenced by the application server 10 upon start of operation, and the IP address of the application server 10 is notified only to the client terminals VC11, VC21, . . . VCn1 as the representative of each group.

Therefore, one application server 10 does not occupy the communication line 1 upon transmission of IP address, and the traffic on the communication line 1 can be decreased.

Further, in the first embodiment, by comparing the IP addresses included in the connection information acquisition request sent from the representative client terminals VC11, VC21, . . . VCn1 with the IP addresses in the group table of the storage device DB in the application server 10, the connection information is judged to be set in the client terminals VC11, VC21, . . . VCn1, and adequate connection information is sent from the application server 10 to the client terminals VC11, VC21, . . . VCn1.

Therefore, the connection information stored and managed in the application server 10 can be set in the processor 24 of the client terminals VC11, VC21, VCn1, without manual operations by the system administrator.

### EMBODIMENT 2

FIG. 6 is a block diagram showing the function/configuration of the other client terminals than the representative, as a second embodiment of the invention. Here, the client terminal VC12 will be explained as the represent.

The client terminal VC12 has a line interface 31, a control unit 32, and a processor 33. The line interface 31 is used for interfacing with the communication line 1.

The control unit 32 has an IP address acquiring unit 321 (hereinafter, called a acquiring unit 321), a communication controller 322, and a connection information setting controller 323 (hereinafter, called a setting controller 323), in addition to the control function for realizing operations as the client terminal VC12.

The acquiring unit 321 sends a request to get the IP address of the application server 10 to the representative client terminal VC11 by using a broadcast, and receives the IP address of the application server 10 sent from the client terminal VC11 in response to the request.

The communication controller 322 is used for communication with the application server 10 through the communication line 1. The communication controller sends a connection information acquisition request to the application server 10 based on the IP address of the application server 10 sent from the client terminal VC11, and receives the connection information sent from the application server 10 in response to the acquisition request.

The setting controller 323 sets the connection information sent from the application server 10 in the processor 33.

Next, explanation will be given on the operation of the communication system configured as described above.

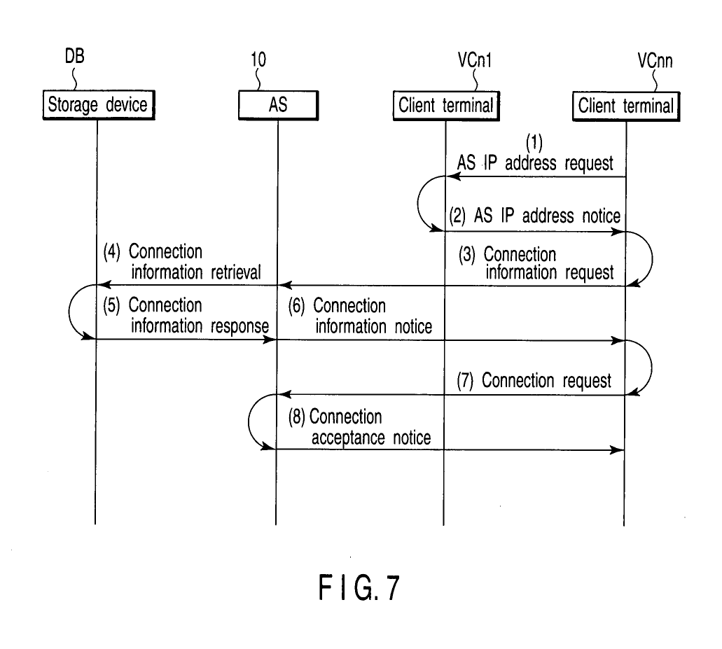

FIG. 7 shows the sequence of information transmission/reception among the application server 10, storage device DB, representative client terminal VCn1 and other clients terminals VCnn, when obtaining and setting the connection information.

The client terminal VCnn requests the IP address of the application server 10 by using a broadcast (FIG. 7 (1)).

The client terminal VCn1 responds to the broadcast of the client terminal VCnn, and informs the client terminal VCnn of the IP address of the application server 10 stored by the client terminal VCnn (FIG. 7 (2)).

The client terminal VCnn sends a connection information acquisition request to the application server 10, based on the IP address of the informed application server 10 (FIG. 7 (3)).

The application server 10 retrieves appropriate connection information for connecting the client terminal VCn1 from the storage device DB, based on the IP address accompanying with the acquisition request received from the client terminal VCnn (FIG. 7 (4)).

The storage device DB returns the connection information selected as a result of retrieval to the application server 10 (FIG. 7 (5)).

The application server 10 informs the client terminal VCnn of the connection information returned from the storage device DB (FIG. 7 (6)).

The client terminal VCnn sets the connection information returned from the application server 10 in the processor 33, and requests the application server 10 to make connection, based on that connection information (FIG. 7 (7)).

The application server 10 makes connection to the client terminal VCnn, and informs the client terminal VCnn of the acceptance of connection (FIG. 7 (8)). The client terminal VCnn makes display to indicate under-connection upon receipt of the acceptance of connection.

The above steps are executed parallel for the subnets 1-n.

As explained above, in the second embodiment, a request to acquire the IP address of the application server 10 is sent from the client terminal VC12 to the client terminal VC11, for example, by a broadcast in the subnet 1, and the connection information is acquired between the client terminal VC12 and application server 10 and the connection information is set in the processor 33, by using the IP address of the application server 10 stored and managed in the management table of the client terminal VC11.

Therefore, appropriate connection information can be set in the client terminal VC12 in a simple procedure, without acquiring the IP address from the application server 10.

### OTHER EMBODIMENTS

The invention is not to be limited to the embodiments described hereinbefore. For example, in the first and second embodiments, the application server and storage device are separately provided, but a group table may be stored in the storage unit in the application server.

The configurations and kinds of communication system, application server and client terminals, and the procedure and contents to control the application server and client terminals, when acquiring and setting the connection information, may also be embodied in other specific forms without departing from its spirit or essential characteristics of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system comprising:
a plurality of communication terminals are connected a communication network, are assigned terminal IDs, and execute communication by setting in a processor a connection information necessary for execution of communication among the communication terminals;
a server apparatus is connected the communication terminals through the communication network, is assigned server ID, and informs the communication terminals of the connection information;
wherein the server apparatus comprises a first memory which stores a group table which correlates with the groups formed by dividing the communication terminals, a terminal ID of a first communication terminal as the representative of the groups, a terminal ID of a second communication terminal different from the first communication terminal, and the connection information;
a notifying unit to refer to the group table, and notify a first communication terminal in each group of a server ID, based on a result of reference; and
a first transmitter which compares the terminal ID of the first communication terminal included in the acquisition request with terminal IDs in the group table, when the connection information acquisition request is sent from the first communication terminal in response to the notification of server ID, and transmits adequate connection information in the group table to the first communication terminal, based on a result of comparison, and
the first communication terminal comprises a second memory which stores the server ID when the server ID is notified by the server apparatus;
a second transmitter which transmits the connection information acquisition request to the server apparatus, based on the server ID stored in the second memory; and
a controller which sets the connection information in the processor, when the connection information is sent from the server apparatus in response to the acquisition request.

2. The communication system according to claim 1, wherein the controller informs the user of the acceptance of connection, when acceptance of connection is informed by the server apparatus.

3. The communication system according to claim 1, wherein the first communication terminal includes a third transmitter which transmits the server ID stored in the second memory to the second communication terminal in response to the server ID acquisition request from the second communication terminal, and
the second communication terminal includes a fourth transmitter which transmits the server ID acquisition request in the group by a broadcast; and a communication controller which transmits the connection information acquisition request to the server apparatus based on the server ID sent from the first communication terminal, and sets the connection information in the processor, when the connection information is sent from the server apparatus in response to the transmission of the acquisition request, and
the first transmitter of the server apparatus compares the terminal ID of the second communication terminal included in the acquisition request with the terminal ID in the group table, when the connection information acquisition request is sent from the second communication terminal, and transmits adequate connection information in the group table to the second communication terminal.

4. The communication system according to claim 3, wherein the communication controller of the second communication terminal informs the user of the acceptance of connection, when acceptance of connection is informed by the server apparatus.
